(19) United States
(12) Patent Application Publication
(10) Pub. No.: US 2026/0061494 A1
(43) Pub. Date: Mar. 5, 2026

(54) BUILD STATE ESTIMATION SYSTEM AND BUILD STATE ESTIMATION METHOD

(71) Applicant: Sodick Co., Ltd., Yokohama (JP)

(72) Inventors: Masahiro TAKANO, Kanazawa (JP); Yuta YOSHIDA, Kanazawa (JP); Hiroyasu MIYAKAWA, Kanazawa (JP); Kenji ISHIBASHI, Yokohama (JP); Yasuyuki MIYASHITA, Yokohama (JP); Ichiro ARAIE, Yokohama (JP)

(73) Assignee: Sodick Co., Ltd., Yokohama (JP)

(21) Appl. No.: 19/292,267

(22) Filed: Aug. 6, 2025

(30) Foreign Application Priority Data
Aug. 30, 2024 (JP) 2024-148331

(51) Int. Cl. B22F 10/80; B22F 10/28; B33Y 50/00; G06T 7/73

(52) U.S. Cl. CPC B22F 10/80; B22F 10/28; G06T 7/75; B33Y 50/00; G06T 2207/20081; G06T 2207/30136

(57) ABSTRACT

A system estimates a build state of a build object. The system includes an image acquisition unit and an analysis unit. The build object is manufactured by repeating: forming a material layer by supplying material powder onto a build area, and forming a solidified layer by irradiating the material layer with one or more laser beams. The image acquisition unit acquires, in real time, an image of spatter around each molten pool formed by the irradiation of the laser beams. The analysis unit extracts at least one feature related to the spatter from the image, calculates coordinates indicating a position of the molten pool, estimates a local parameter representing the build state of the solidified layer by inputting the at least one feature to a trained model, and outputs the local parameter in a form associated with the coordinates.

### CROSS-REFERENCE TO RELATED APPLICATION

This application claims priority to Japanese Patent Application No. 2024-148331, filed on Aug. 30, 2024, the entire contents of which are incorporated by reference herein.

### BACKGROUND

The present invention relates to a system and method applicable to the estimation of the build state of a three-dimensionally built object.

In manufacturing sites, rapid prototyping, represented by three-dimensional additive manufacturing, is attracting attention, and in recent years, rapid manufacturing, which applies rapid prototyping techniques to obtain final products, has been gaining increasing attention. For example, Japanese Patent Publication No. 2022-121427 discloses an additive manufacturing apparatus directed to laser additive manufacturing (LAM).

In the additive manufacturing apparatus described in Japanese Patent Publication No. 2022-121427, images of spatter generated by irradiation of a material layer with a laser beam are acquired at an appropriate sampling rate, and by analyzing these images, a “virtual porosity” as a parameter indicating the build state of the build object is estimated. In the technique described in Japanese Patent Publication No. 2022-121427, by monitoring this “virtual porosity”, it is determined whether or not the solidified layer is properly formed, and the irradiation condition of the laser beam is corrected according to the determination result.

### SUMMARY

However, although the technique described in Japanese Patent Publication No. 2022-121427 can detect undesirable fluctuations in laser irradiation conditions during the execution of additive manufacturing, it has not always been suitable for evaluating whether or not a completed build object has been manufactured as intended. Regarding the quality of a build object, it would be beneficial if more detailed information could be obtained, for example, without destroying the finished product.

According to the present invention, the following are provided.
[1] A system for estimating a build state of a build object, comprising an image acquisition unit and an analysis unit, wherein the build object is manufactured by repeating a material layer forming step of supplying material powder onto a build area to form a material layer, and a solidified layer forming step of irradiating the material layer with one or more laser beams to form a solidified layer, the image acquisition unit acquires, in real time, an image of spatter generated around each molten pool formed by the irradiation of the one or more laser beams, and the analysis unit executes extraction of at least one feature related to the spatter from the image and calculation of coordinates indicating a position of the molten pool, estimates a local parameter representing the build state of the solidified layer by inputting the at least one feature to a trained model, and outputs the local parameter in a form associated with the coordinates.
[2] The system of [1], wherein the local parameter is data representing a porosity of each part of the build object, associated with respective coordinates.
[3] The system of [1] or [2], wherein the analysis unit generates a three-dimensional image related to the build state of the build object, represented by point cloud data which is a collection of individual data sets, where each data set consists of the coordinates and the associated local parameter.
[4] The system of any of [1] to [3], further comprising a control unit, wherein the control unit controls an operation of a recoater head that supplies the material powder onto the build area, the coordinates include a Z coordinate value related to a height direction of the build object in addition to planar coordinates within the build area, and the analysis unit calculates the Z coordinate value by determining a cumulative number of laminated layers of the solidified layer by detecting an image including the recoater head among a series of images acquired by the image acquisition unit.
[5] The system of any of [1] to [3], further comprising a control unit, wherein the coordinates include a Z coordinate value related to a height direction of the build object in addition to planar coordinates within the build area, and the analysis unit calculates the Z coordinate value by determining a cumulative number of laminated layers of the solidified layer by analyzing a log of commands from the control unit.
[6] The system of [4] or [5], wherein the control unit changes an irradiation condition of at least one of the laser beams according to an estimated value of the local parameter.
[7] The system of any of [1] to [6], wherein the one or more laser beams include a plurality of laser beams, and the analysis unit executes extraction of the at least one feature for each molten pool and calculation of the coordinates indicating a position of a respective molten pool from the image.
[8] A method of estimating a build state of a build object, comprising an image acquisition step and an analysis step, wherein the build object is manufactured by repeating a material layer forming step of supplying material powder onto a build area to form a material layer, and a solidified layer forming step of irradiating the material layer with one or more laser beams to form a solidified layer, wherein the irradiation forms one or more molten pools within the material layer, wherein the image acquisition step comprises acquiring, in real time, an image of spatter generated around each of the molten pools, and wherein the analysis step comprises estimating a local parameter representing the build state of the solidified layer by inputting at least one feature related to the spatter to a trained model, and outputting the local parameter in a form associated with coordinates indicating a position of a respective one of the molten pools.
[9] The method of [8], wherein the analysis step comprises a step of extracting the at least one feature from the image and a step of calculating the coordinates from the image.

In embodiments of the present invention, not only is a local parameter representing the build state of a solidified layer estimated from an image of spatter, but also coordinates of a molten pool are calculated from the image of spatter. Embodiments of the present invention make it possible to obtain an estimated value of the local parameter in a form linked to the three-dimensional shape of the build object, so that, for example, a designer of the build object can visually determine the quality of the finished product.

### BRIEF DESCRIPTION OF THE DRAWINGS

FIG. 1 schematically shows an exemplary build state estimation system according to an embodiment of the present invention.

FIG. 2 is an external perspective view of a material layer forming device 130.

FIG. 3 is a schematic top perspective view of a recoater head 136 of the material layer forming device 130.

FIG. 4 is a schematic bottom perspective view of the recoater head 136 of the material layer forming device 130.

FIG. 5 is a schematic diagram illustrating the arrangement of material powder in a build area R.

FIG. 6 is a diagram schematically showing an exemplary configuration of a laser irradiation device 140.

FIG. 7 is a schematic diagram illustrating an example of an image of spatter S acquired by an image acquisition unit 110.

FIG. 8 is an exemplary functional block diagram of a build state estimation system 1000.

FIG. 9 is a schematic diagram showing an exemplary visualization of porosity by the build state estimation system 1000.

FIG. 10 is a schematic diagram showing another example in which porosity is three-dimensionally visualized in association with the shape of a build object.

FIG. 11 is a flowchart illustrating an exemplary build state estimation method according to another embodiment of the present invention.

FIG. 12 is a diagram showing steps that may be included in step S5 shown in FIG. 11.

FIG. 13 is a diagram showing steps that may be included in step S9 shown in FIG. 11.

FIG. 14 is a diagram schematically showing an exemplary build state estimation system according to still another embodiment of the present invention.

FIG. 15 is a schematic diagram for illustrating another example of an image of spatter S acquired by the image acquisition unit 110.

FIG. 16 is a functional block diagram of a build state estimation system according to still another embodiment of the present invention.

### DESCRIPTION

As will be described in detail later with reference to the drawings, in a typical embodiment of the present invention, a three-dimensionally built object is obtained by a method similar to the additive manufacturing described in Japanese Patent Publication No. 2022-121427. More specifically, a build object is manufactured by repeating a material layer forming step and a solidified layer forming step. In the material layer forming step, material powder is supplied onto a predetermined build area to form a material layer. In the solidified layer forming step, the material layer is irradiated with one or more laser beams to form a solidified layer. That is, the entire shape of the build object is completed by sequentially forming a plurality of solidified layers, each having a predetermined thickness.

According to the technique described in Japanese Patent Publication No. 2022-121427, a “virtual porosity” related to the build object can be obtained without destroying the build object by acquiring an image of spatter generated around an irradiation spot during manufacturing (hereinafter may be referred to as a “spatter image”). The acquisition of the spatter image can be performed multiple times during manufacturing.

According to the technique described in Japanese Patent Publication No. 2022-121427, it is possible to grasp the transition of “virtual porosity” in the manufacturing process of a build object. However, the values of these “virtual porosities” are merely given for each acquired spatter image and are not obtained in a form corresponding to the three-dimensional shape of the build object. Therefore, merely grasping the value of “virtual porosity” is sometimes insufficient for accurately determining the quality of the finished product. For example, when a structure having a low density is intentionally provided inside a build object, a relatively high value of “virtual porosity” may be estimated locally. Alternatively, a relatively low value of “virtual porosity” might be estimated. In such a case, merely monitoring the transition of “virtual porosity” may not allow for a correct evaluation of the quality of the finished product.

The quality of a completed build object can be evaluated, for example, by cross-sectional observation, based on the ratio of voids in a certain area. However, cross-sectional observation is a destructive inspection of a specific cross-section, and it is practically impossible to observe all cross-sections of a build object. Adoption of non-destructive inspection using ultrasonic testing or X-ray inspection might be worth considering, but preparing a high-precision inspection device for each completed build object and inspecting the finished product just for repeated manufacturing is also unrealistic from the viewpoint of cost and effort.

The present inventors have completed the present invention after repeated studies in view of the above circumstances. As will be described later, according to a typical embodiment of the present invention, it is possible to, for example, estimate the local porosity of a spot irradiated with a laser beam and its surroundings from a spatter image during processing, and also to calculate the coordinates of a molten pool. Thus, embodiments of the present invention allow for the extraction of more detailed information regarding the quality of a completed build object from a spatter image. As a result, the quality of a completed build object can be, for example, easily visually assessed, enabling a more accurate and reliable quality determination.

Hereinafter, embodiments of the present invention will be described. Various features illustrated in the embodiments described below can be combined with each other. In addition, an invention is independently established for each feature.

### 1. Exemplary Embodiment of Build State Estimation System

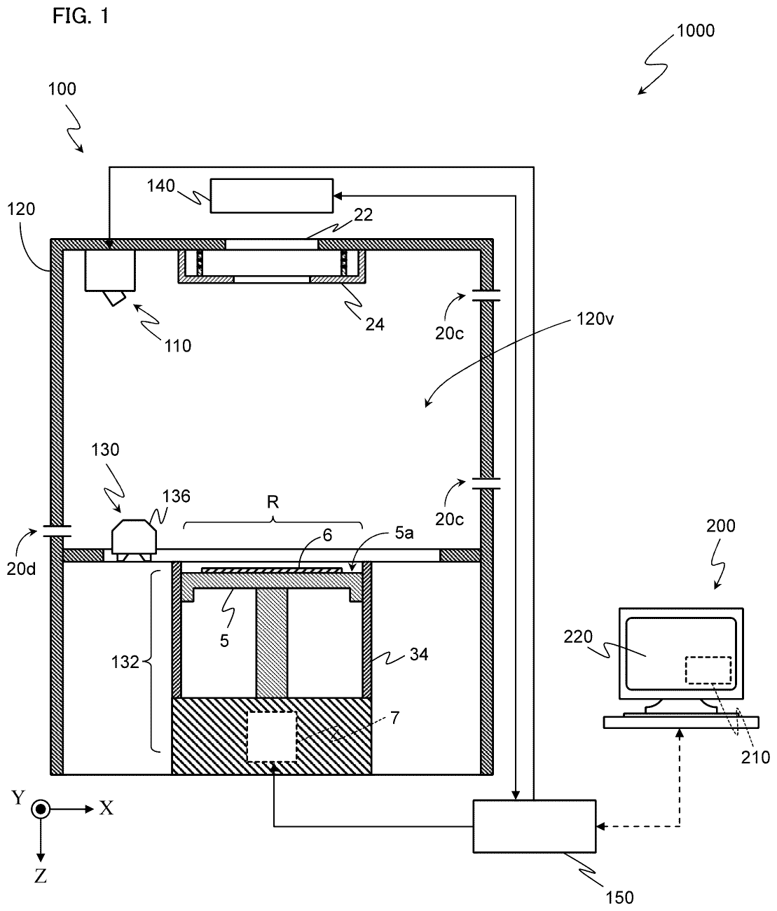

FIG. 1 shows an exemplary build state estimation system according to an embodiment of the present invention. The build state estimation system 1000 shown in FIG. 1 includes an additive manufacturing device 100 and an external computing device 200. For convenience of explanation, three arrows indicating mutually orthogonal X, Y, and Z axes are drawn in FIG. 1. Herein, the Z-axis in the figure is parallel to the vertical direction. In other drawings subsequent to FIG. 1, arrows indicating these X, Y, and Z axes may also be shown.

The additive manufacturing device 100 of the build state estimation system 1000 has a build area R where a build object is formed by laser irradiation of a material layer. The additive manufacturing device 100 further has an image acquisition unit 110. The image acquisition unit 110 includes one or more cameras, each capable of imaging the build area R. In the configuration illustrated in FIG. 1, the image acquisition unit 110 is a digital still camera or a digital video camera arranged above the build area R.

The external computing device 200 of the build state estimation system 1000 is, for example, a personal computer communicably connected to the additive manufacturing device 100 via a wired or wireless connection. The external computing device 200 has one or more processors and one or more memories. As schematically shown in FIG. 1, the external computing device 200 includes an analysis unit 210 and a display unit 220 such as a liquid crystal panel. The analysis unit 210 may be implemented by the processors executing instructions stored in the memories of the external computing device 200, and analyzes images acquired by the image acquisition unit 110 of the additive manufacturing device 100.

As will be described in detail later, in a typical embodiment of the present invention, the image acquisition unit 110 of the additive manufacturing device 100 acquires an image of spatter generated by laser irradiation of a material layer formed in the build area R. The analysis unit 210 of the external computing device 200 extracts one or more features from the image acquired by the image acquisition unit 110. Further, the analysis unit 210 calculates coordinates indicating the position of a molten pool formed by laser irradiation from the spatter image. The analysis unit 210 estimates a parameter (e.g., porosity) representing the build state of the solidified layer using a trained model, and outputs it in a form associated with the coordinates indicating the position of the molten pool. An example of this output will be described later.

### (1.1 Additive Manufacturing Device 100)

Hereinafter, first, a configuration example of the build state estimation system 1000, and in particular of the additive manufacturing device 100, will be described. A configuration similar to the additive manufacturing apparatus described in Japanese Patent Publication No. 2022-121427 can be adopted as the additive manufacturing device 100. The entire disclosure of Japanese Patent Publication No. 2022-121427 is incorporated herein by reference. Herein, an overly detailed description of the specific configuration of the additive manufacturing device 100 will be avoided, and only an outline will be described.

As shown in FIG. 1, the additive manufacturing device 100 has a chamber 120 in addition to the above-described image acquisition unit 110. Furthermore, the additive manufacturing device 100 has a material layer forming device 130, a laser irradiation device 140, and a control unit 150. The control unit 150 includes, as a part thereof, a controller that controls the operations of the material layer forming device 130 and the laser irradiation device 140. As will be described later, the additive manufacturing device 100 may further include a temperature sensor for monitoring the temperature of the molten pool.

### (1.1.1 Chamber 120)

The chamber 120 is a structure that encloses the build area R and may have, for example, a door on its front surface for accessing a build space 120v inside the chamber 120. When performing additive manufacturing, an inert gas of a predetermined concentration is introduced into the build space 120v from an inert gas supply device (not shown in FIG. 1) via an inlet 20c provided in the chamber 120.

As the inert gas, a gas that does not substantially react with the material layer and/or the solidified layer formed in the build area R can be used. The inert gas is appropriately selected according to the material powder used for additive manufacturing. Typical examples of the inert gas include nitrogen gas, argon gas, and helium gas. By filling the inside of the chamber 120 with an inert gas, the oxygen concentration in the build space 120v can be kept sufficiently low. For example, in metal additive manufacturing, keeping the oxygen concentration in the build space 120v low contributes to suppressing deterioration of the material powder constituting the material layer and to stable irradiation of the laser beam onto the material layer.

The inert gas introduced into the chamber 120 is recovered from an exhaust port 20d. The discharged gas is sent to a fume collector (not shown), and fumes in the gas are removed by the fume collector, and the purified gas is then returned to the inside of the chamber 120. That is, the inert gas can be circulated between the chamber 120 and the fume collector. Examples of the fume collector include a dry electrostatic precipitator and a filtration-type dust collector.

### (1.1.2 Material Layer Forming Device 130)

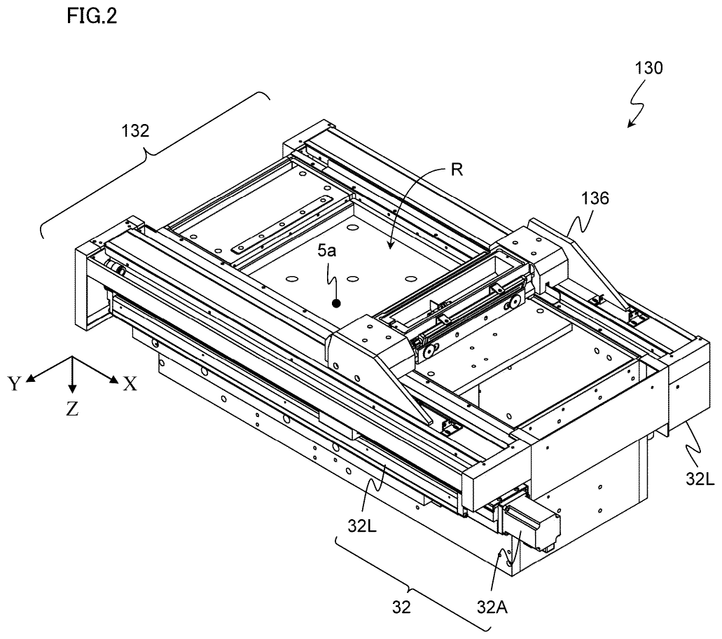

FIG. 2 shows an exemplary external appearance of the material layer forming device 130 taken out from the additive manufacturing device 100. The material layer forming device 130 includes a base 132 and a recoater head 136 movable on the base 132.

The base 132 has a drive mechanism 32 for the recoater head 136. In the configuration illustrated in FIG. 2, the drive mechanism 32 includes two guide rails 32L, each extending along the X-axis in the figure, and an actuator 32A such as a servomotor. Herein, the two guide rails 32L, each extending parallel to the X-axis, are arranged spaced apart along the Y-axis. The recoater head 136 is supported by these guide rails 32L and can be reciprocated along the X-axis by the actuator 32A.

As schematically shown in FIG. 2, the build area R is located between these guide rails 32L. In other words, the recoater head 136 can be installed in the material layer forming device 130 so as to straddle the build area R. Herein, the shape of the build area R in a plan view seen in the positive direction of the Z-axis is rectangular, and one side of this rectangular shape is parallel to the X-axis. However, the build area R is not limited to a rectangular shape. The build area R may have a circular shape, an oval shape, an elliptical shape, or the like in a plan view.

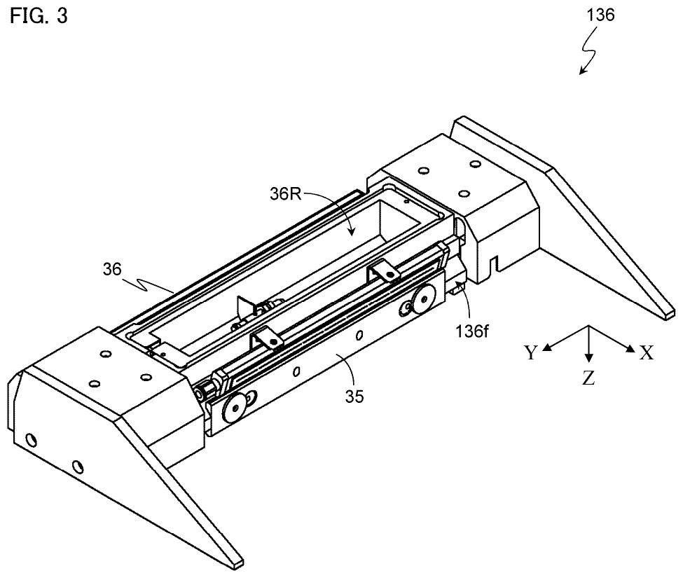

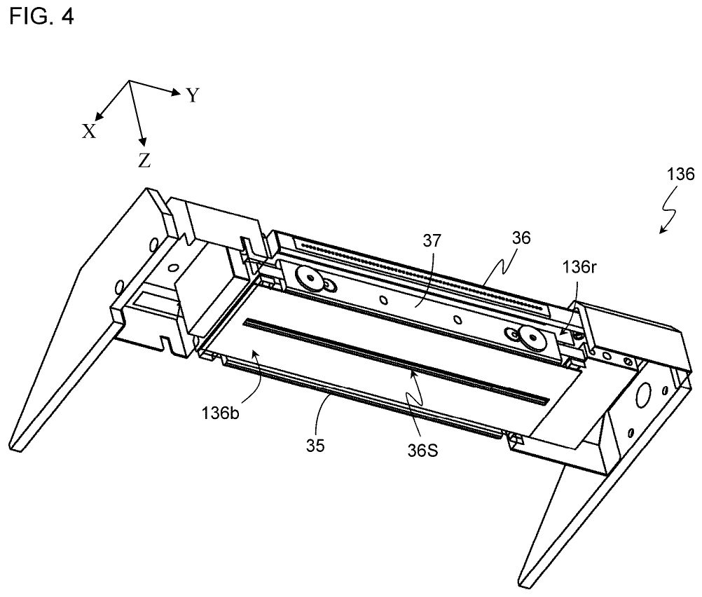

FIGS. 3 and 4 show the recoater head 136 taken out from the material layer forming device 130. The recoater head 136 includes a main body portion 36 of a rectangular parallelepiped shape extending along the Y-axis. As shown in FIG. 3, here, the main body portion 36 has a reservoir 36R that opens upward. The reservoir 36R temporarily stores material powder for forming a material layer.

As shown in FIG. 4, a slit 36S communicating with the reservoir 36R is provided on a bottom surface 136b of the recoater head 136. Through the slit 36S, the material powder stored in the reservoir 36R can be supplied to the build area R by moving the recoater head 136. As shown, a blade 35 and a blade 37 for leveling the material powder applied to the build area R may be provided on a front surface 136f and a rear surface 136r of the recoater head 136, respectively.

Reference is again made to FIG. 1. As schematically shown in FIG. 1, the base 132 of the material layer forming device 130 includes retaining walls 34 that extend downward from the plane on which the recoater head 136 is arranged. The retaining walls 34 have an arrangement surrounding the build area R, and here, corresponding to the build area R having a rectangular shape, the base 132 includes four retaining walls 34.

The base 132 of the material layer forming device 130 further includes a build table 5 and an actuator 7. The build table 5 is arranged in a tubular space (which may be called a “shaft”) defined by the retaining walls 34 and can be moved up and down in predetermined steps along the Z-axis by the actuator 7. The amount of movement of the build table 5 per step is, for example, in the range of 20 μm to 200 μm, and preferably in the range of 30 μm to 70 μm. Here, the amount of movement per step of the build table 5 is 50 μm. An upper surface 5a of the build table 5 corresponds to the above-mentioned build area R.

After lowering the build table 5 by a predetermined step, by supplying material powder from the recoater head 136 while moving the recoater head 136 along the X-axis into the space created by the lowering of the build table 5, a material layer having a predetermined thickness can be formed on the build area R. Typically, a base plate 6 that can be removed from the build table 5 is placed on the upper surface 5a, and a build object is formed on the base plate 6.

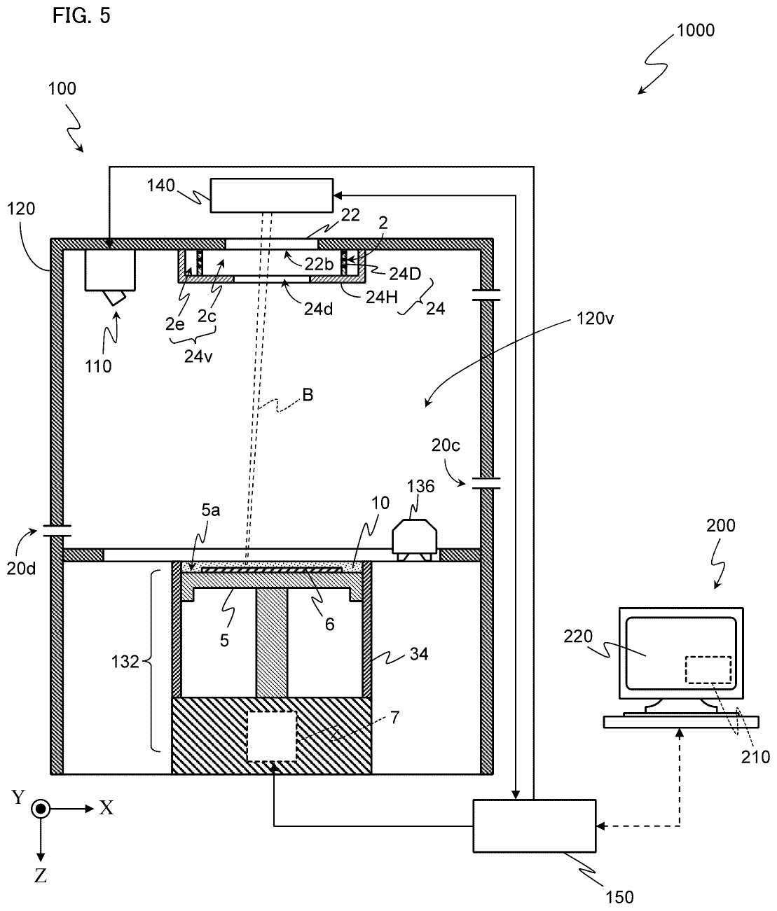

FIG. 5 illustrates the formation of a material layer on the build area R. For example, when the recoater head 136 is moved along the X-axis from the position shown in FIG. 1 to the position shown in FIG. 5, material powder is supplied from the recoater head 136 into the space created by the lowering of the build table 5. By moving the recoater head 136, as schematically shown in FIG. 5, a material layer 10 can be formed on the build area R. The thickness of the newly created layer corresponds to the vertical distance between the upper surface 5a of the build table 5 and the tips of the blades 35 and 37. If the base plate 6 is provided on the upper surface 5a of the build table 5, the effective thickness of the material layer 10 is determined by the vertical distance from the surface of the base plate 6 to the tips of the blades 35 and 37. The actuator 7 for moving the build table 5 up and down and the actuator 32A (see FIG. 2) for moving the recoater head 136 are driven under the control of the control unit 150.

### (1.1.3 Laser Irradiation Device 140)

After the formation of the material layer 10 on the build area R, laser irradiation on the material layer 10 is performed. In the example shown in FIG. 5, a laser irradiation device 140 is installed above the chamber 120, and the material layer 10 is irradiated from above with a laser beam B emitted from the laser irradiation device 140. Although the example shown in FIG. 5 shows an example where the material layer 10 is irradiated with a single laser beam B, it is also possible for the material layer 10 to be simultaneously irradiated with multiple laser beams if the additive manufacturing device includes multiple laser irradiation devices, as will be described later.

In the example shown in FIG. 5, the laser beam B from the laser irradiation device 140 irradiates the material layer 10 via a window 22 provided on the upper part of the chamber 120. Examples of the material for the window 22 include quartz glass or borosilicate glass, or crystals such as germanium, silicon, zinc selenide, or potassium bromide, and may be appropriately selected according to the laser source. If a fiber laser or a YAG laser is used as the laser source, a quartz glass plate can be used for the window 22.

As shown in FIG. 5, a fume diffusion unit 24 for preventing adhesion of fumes to the window 22 may be provided inside the chamber 120. The fume diffusion unit 24 has a shape that covers the window 22 from below. In this example, the fume diffusion unit 24 includes, for example, a cylindrical housing 24H and a diffusion member 24D provided with a large number of perforations 2. The diffusion member 24D has, for example, a cylindrical shape similar to the housing 24H. As schematically shown in FIG. 5, the diffusion member 24D is arranged in a space 24v defined by the ceiling of the chamber 120 and the housing 24H, thereby separating the space 24v into two sub-spaces. However, these sub-spaces are in communication with each other because the diffusion member 24D has perforations 2.

During the additive manufacturing, clean inert gas from the above-mentioned inert gas supply device (not shown) is supplied to the outer sub-space 2e of the two sub-spaces partitioned by the diffusion member 24D. The inert gas introduced into the sub-space 2e passes through the perforations 2 of the diffusion member 24D and flows into the sub-space 2c surrounded by the diffusion member 24D. The clean inert gas introduced into the sb-space 2c via the perforations 2 is discharged into the build space 120v from an opening 24d provided in a portion of the housing 24H located below the window 22.

As shown in FIG. 5, a lower surface 22b of the window 22 is exposed to the above-mentioned sub-space 2c. By filling the sub-space 2c with clean gas and discharging the gas toward the build space 120v, the entry of fumes into the sub-space 2c can be reduced. By preventing the entry of fumes into the sub-space 2c, the adhesion of fumes to the window 22 can be greatly reduced.

By irradiating the material layer 10 with the laser beam B through the window 22 of the chamber 120 and the opening 24d of the fume diffusion unit 24, a part of the material powder constituting the material layer 10 can be melted or sintered. By cooling after the irradiation of the laser beam B, a solidified layer is formed from the melted or sintered material powder. That is, through the irradiation of the laser beam B, a part of the layer of the material powder can be selectively transformed into a solidified layer.

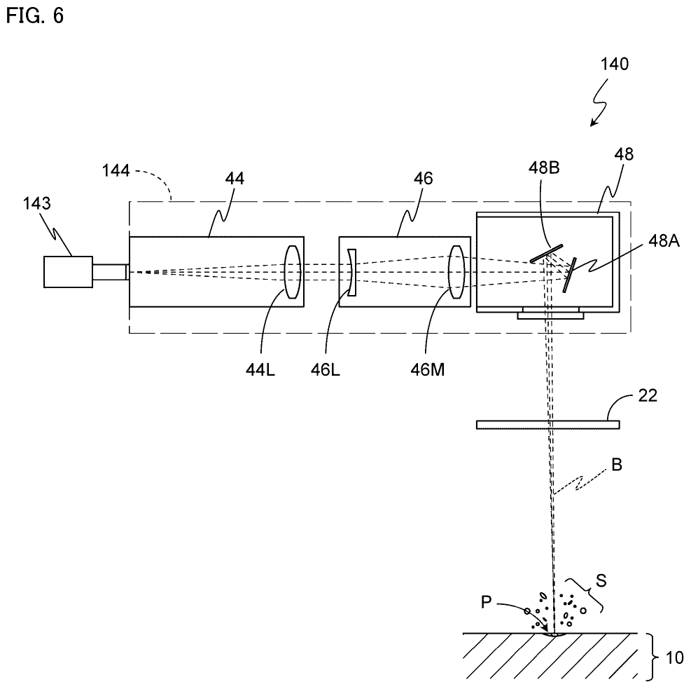

FIG. 6 shows an exemplary configuration of the laser irradiation device 140. In the configuration illustrated in FIG. 6, the laser irradiation device 140 includes a laser oscillator 143 and a galvanometer unit 144, which serves as a scanning optical system. The operations of the laser oscillator 143 and the galvanometer unit 144 are controlled by a laser control unit to be described later.

For the laser oscillator 143, a laser source that can provide a laser output capable of melting or sintering the material powder can be applied without any particular limitation. Examples of the laser source include a fiber laser, a CO₂ laser, and a YAG laser.

In the example shown in FIG. 6, the galvanometer unit 144 includes a collimator 44, a focus control unit 46, and a galvanometer 48. The collimator 44 includes a collimator lens 44L inside and shapes the laser emitted from the laser oscillator 143 into a parallel beam. The focus control unit 46 includes, for example, a movable lens 46L and a condensing lens 46M inside and adjusts the beam diameter of the parallel beam from the collimator 44. The movable lens 46L of the focus control unit 46 is movable along the optical axis of the beam by an actuator (not shown), and by adjusting the position of the movable lens 46L, the focal position of the laser beam B irradiated onto the material layer 10 can be adjusted. The number of lenses and the shape of each lens shown in FIG. 6 are merely exemplary and are not intended to limit the actual configuration.

The galvanometer 48 includes a first galvanometer mirror 48A and a second galvanometer mirror 48B, each connected to an actuator (not shown) to be independently rotatable. The galvanometer 48 steers the beam that has passed through the focus control unit 46 under the control of the laser control unit. The laser irradiation device 140, by steering using the galvanometer 48, can two-dimensionally scan the laser beam B on the material layer 10 and selectively melt or sinter the material powder in the portion of the material layer 10 irradiated with the laser beam B.

### (1.2 External Computing Device 200)

Next, attention is turned to the external computing device 200 of the build state estimation system 1000. As described with reference to FIG. 1, the external computing device 200 includes an analysis unit 210. In a typical embodiment of the present invention, the analysis unit 210 is generally responsible for the following three functions.

The first is to acquire a spatter image obtained by the image acquisition unit 110 of the additive manufacturing device 100 and to extract one or more features related to the spatter from the spatter image. The second is to calculate a coordinates indicating the position of a molten pool formed by the irradiation of the laser beam. The third is to output a local parameter representing the build state of the solidified layer in a form associated with the coordinates indicating the position of the molten pool. As will be described in detail later, in embodiments of the present invention, the analysis unit 210 estimates a local porosity as a local parameter by inputting the features extracted from the spatter image into a trained model.

### (1.2.1 Extraction of Features Related to Spatter)

As schematically shown in FIG. 6, when the material layer 10 formed in the build area R by the recoater head 136 is irradiated with the laser beam B, some of the material powder at the irradiated location among the material powder constituting the material layer 10 melts to form a molten pool P, and spatter S is generated around the molten pool P. In this specification, “spatter S” refers to particles scattered from the molten pool P or its surroundings during laser irradiation. The substance of spatter S may include molten metal particles and unmelted material powder scattered from the molten pool P.

The image acquisition unit 110 of the additive manufacturing device 100 captures images of the build area R, for example, at predetermined intervals (i.e., at a predetermined frame rate), and transmits image data of the spatter S to the external computing device 200. The frame rate of the capture is, for example, in the range of 5 fps to 10000 fps, and preferably in the range of 10 fps to 3000 fps.

Typically, the size of the field of view (FOV) of the image acquisition unit 110 is set so that the entire build area R is included in the image plane. In this embodiment, the acquisition of the images of the spatter S by the image acquisition unit 110 is performed in real time during additive manufacturing. The acquisition of the images of the spatter S is not limited to constant intervals and may be performed at irregular intervals.

The analysis unit 210, upon receiving the image data from the image acquisition unit 110, extracts at least one feature related to spatter S by image analysis. Such features related to spatter S include, for example, one or more of the following:
a luminance value at the center of the spatter particle;
a luminance value of the red component (R component) at the center of the spatter particle;

a luminance value of the green component (G component) at the center of the spatter particle;
a ratio of G component to R component (G/R);
a distance between the center of the spatter particle and the molten pool;
a distance in the X direction between the spatter particle center and the molten pool;
a distance in the Y direction between the spatter particle center and the molten pool;
a ratio of the lengths of the major axis and minor axis when the outer shape of the spatter particle is approximated by an ellipse (aspect ratio);
a ratio of the length and the width when the outer shape of the spatter particle is approximated by a rectangle (elongation rate);
a hydraulic diameter when the outer shape of the spatter particle is regarded as a cross-section of a non-circular tube;
a perimeter L of the spatter particle;
an area A of the spatter particle;
a total number of spatter particles; and
a total number of spatter particles sorted based on one or more of the above features.
   The feature extraction may be performed on a single spatter particle or on a plurality of spatter particles captured in the image. As used herein, the one or more particles subjected to feature extraction may be collectively referred to as “spatter particles”.

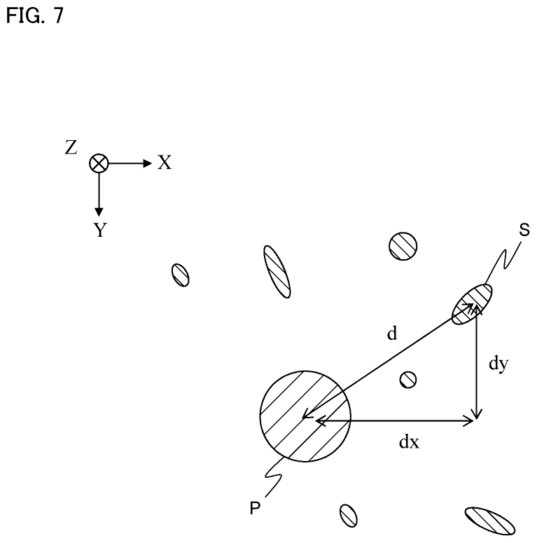

FIG. 7 shows an example of an image of spatter S acquired by the image acquisition unit 110. FIG. 7 illustrates particles scattered generally toward the upper right of the figure with the position of the molten pool P as the center. As can be understood from FIG. 7, the “image of spatter S” in this specification refers to an image that includes not only an image of spatter particles but also an image of the molten pool P. Typically, the molten pool P includes the brightest part in the image and is identified as an approximately circular region among a set of pixels brighter than a certain threshold. Spatter particles can also be identified as regions including pixels with relatively high luminance in the image. Here, one particle with the largest area among a plurality of relatively bright regions is taken as representative of the spatter particles.

In FIG. 7, the distance indicated by the double-headed arrow d corresponds to the “distance between the center of the spatter particle and the molten pool” mentioned above. The center of the spatter particle can be defined as the position of the geometric center of the outer shape of the spatter particle, and the position of the molten pool can also be represented by the position of the geometric center of its outer shape. In FIG. 7, the distance dx indicated by the double-headed arrow parallel to the X-axis corresponds to the “distance in the X direction between the spatter particle center and the molten pool” mentioned above. Similarly, the distance dy indicated by the double-headed arrow parallel to the Y-axis corresponds to the “distance in the Y direction between the spatter particle center and the molten pool” mentioned above. In FIG. 7, the outer shape of the molten pool P is drawn as a circle, and the outer shape of the spatter particle is drawn as an ellipse or oval. However, it should be noted that these shapes are for illustrative purposes only and are not intended to show the actual shape of the molten pool P or the spatter particle.

The hydraulic diameter D related to a spatter particle can be calculated as D=(4A/L) using the above-mentioned area A and perimeter L. Examples of “total number of spatter particles sorted based on one or more of the above features” can include any of the following counts:
the number of spatter particles whose luminance at the center is greater than or equal to a predetermined value;
the number of spatter particles whose aspect ratio (approximated as an ellipse) is less than a predetermined value; and
the number of spatter particles whose elongation rate is greater than or equal to a predetermined value.

### (1.2.2 Estimation Using Trained Model)

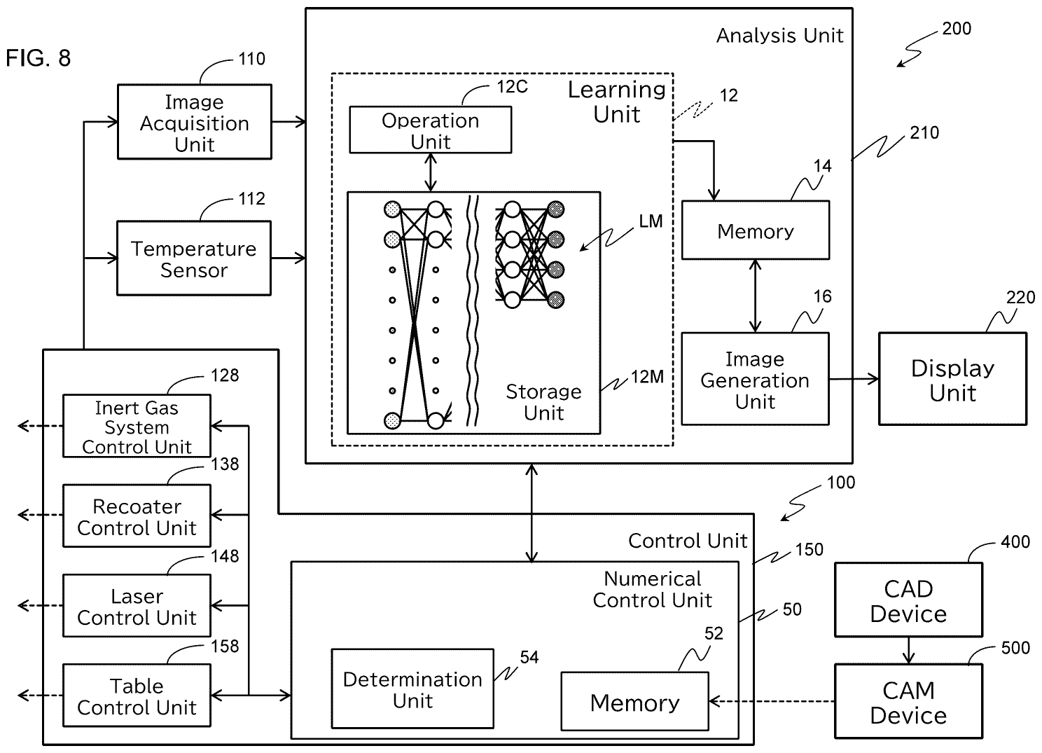

FIG. 8 is an exemplary functional block diagram of the build state estimation system 1000. In the configuration illustrated in FIG. 8, the control unit 150 of the additive manufacturing device 100 includes a numerical control unit 50, an inert gas system control unit 128, a recoater control unit 138, a laser control unit 148, and a table control unit 158.

The inert gas system control unit 128, the recoater control unit 138, the laser control unit 148, and the table control unit 158 are connected to the numerical control unit 50 and function as controllers that control the operation of the mechanisms of each part of the additive manufacturing device 100 based on commands from the numerical control unit 50. For example, the inert gas system control unit 128 controls the operation of the inert gas supply device and the fume collector based on commands from the numerical control unit 50. The recoater control unit 138 drives the actuator 32A (see FIG. 2) and controls the reciprocating motion of the recoater head 136 based on commands from the numerical control unit 50.

In this example, the additive manufacturing device 100 further includes a temperature sensor 112. The temperature sensor 112 is, for example, a radiation thermometer such as a pyrometer, and monitors the temperature of the molten pool P formed by laser irradiation on the material layer 10. The installation of the temperature sensor 112 is not essential for the embodiments of the present invention. However, the output of the temperature sensor 112 may, of course, be supplementarily used for the estimation of the local parameter and/or the calculation of the coordinates indicating the position of the molten pool.

Next, attention is turned to the external computing device 200. In the configuration illustrated in FIG. 8, the analysis unit 210 of the external computing device 200 includes a learning unit 12, a memory 14, and an image generation unit 16. Here, the learning unit 12 includes a storage unit 12M that holds a trained model LM, and an operation unit 12C that executes input to the trained model LM and receives output from the trained model LM. The operation unit 12C also has the function of updating a set of parameters during the training stage of the trained model LM.

The analysis unit 210 receives the image data of spatter S sent from the image acquisition unit 110 of the additive manufacturing device 100. The analysis unit 210 extracts a set of features from the image of spatter S, and inputs this set of features to the trained model LM. The analysis unit 210 obtains a local parameter related to the quality of the build object as an output from the trained model LM. In this embodiment, an estimated value of porosity is exemplified as the local parameter. As used herein, the term “estimation” in this specification refers to a process of predicting or approximating an unknown quantity using the trained model LM.

Here, the porosity output from the trained model LM is related to the position of the molten pool P formed by irradiation with the laser beam B on the material layer 10 at the time of acquisition of the image of spatter S. In other words, the analysis unit 210 obtains the porosity corresponding to the position of the molten pool P for each image of spatter S based on the trained model LM. In that sense, the value of porosity estimated based on the trained model LM in this embodiment is “local”.

The local parameter obtained by the analysis unit 210 based on the input of the features to the trained model LM is not limited to the above-mentioned porosity and may be another type of quantity. The analysis unit 210 may, for example, obtain one or more of the laser power, spot diameter, and laser power density of the laser beam B at the time of acquisition of the image of spatter S as output from the trained model LM. As also described in Japanese Patent Publication No. 2022-121427, the state of laser irradiation on the surface of the material layer can vary from moment to moment due to the influence of fumes and other byproducts generated as building progresses. Therefore, these values obtained from model inference using the trained model LM can also be said to be local estimated values regarding the irradiation location on the material layer 10.

In this way, instead of porosity, or in addition to porosity, other local parameters may be obtained as estimated values from the trained model LM. In addition to the parameters mentioned above, the degree of dryness of the material powder constituting the material layer 10, and the thickness of the material layer 10 at that time, which is the target of irradiation of the laser beam B (that is, the distance from the surface of the material powder layer to the solidified layer under the material powder), etc., may be estimated using the trained model LM. The local parameter may be given as a single value related to porosity, for example, or may be given in the form of a set of estimated values for multiple attributes (for example, a numeric vector having porosity, laser power, and spot diameter as its components).

The estimated value obtained by using the trained model LM is temporarily held in the memory 14 such as a RAM. In a typical embodiment, the memory 14 holds the estimated value obtained for each image of spatter S until additive manufacturing is completed.

### (1.2.3 Calculation of Molten Pool Coordinates)

In addition to extracting features from the image of spatter S, the analysis unit 210 executes the calculation of the coordinates indicating the position of the molten pool P formed by the irradiation of the laser beam B. Herein, the coordinates calculated by the analysis unit 210 include not only the planar coordinates (e.g., X and Y coordinates) of the molten pool P within the build area R but also a Z-coordinate related to the height direction of the build object.

The calculation of the coordinates indicating the position of the molten pool P is typically executed for each image of the spatter S. The calculated coordinates are stored, for example, in the memory 14 together with the estimated value of porosity and held until the additive manufacturing is completed. Hereinafter, the calculation of the planar coordinates (a set of X-coordinate and Y-coordinate) and the calculation of the Z-coordinate will be described separately.

As described above, in a typical embodiment of the present invention, the field of view of the image acquisition unit 110 is adjusted so as to include the entire build area R. Therefore, each of a series of images related to spatter S acquired by the image acquisition unit 110 includes an image of the molten pool P formed by the irradiation of the laser beam B. The image of the molten pool P generally appears as a region with a larger area and higher luminance compared to the spatter S and an approximately circular shape. Therefore, for example, by extracting a region considered to be the molten pool P in the image with an appropriate filter and finding the geometric center of that region, the position of the molten pool P can be represented by the coordinates of the geometric center.

Here, what is ultimately desired to be known in this embodiment is the coordinate values in the world/object coordinate system. On the other hand, the position of the molten pool P in the image of spatter S is expressed by two-dimensional coordinates in the image plane coordinate system. Therefore, in reality, camera calibration is typically performed using a known method before the actual additive manufacturing process. By completing the camera calibration in advance, it becomes possible to convert the planar coordinates related to the position of the molten pool P in the image of spatter S into the XY coordinates in the real world, that is, the XY coordinates in the world coordinate system. This coordinate transformation may be performed, for example, by the analysis unit 210.

The calculation of the XY coordinates related to the position of the molten pool P may be executed based on another method. For example, the analysis unit 210 of the external computing device 200 may obtain information related to the XY coordinates of the molten pool P through the control unit 150 of the additive manufacturing device 100.

In the configuration shown in FIG. 8, the control unit 150 includes the laser control unit 148. This laser control unit 148 is a controller that controls the operation of the galvanometer unit 144 (see FIG. 6). As described below, the analysis unit 210 may obtain information related to the XY coordinates of the molten pool P from the laser control unit 148.

The position of the molten pool P formed in the material layer 10 is related to the steering of the laser beam B. Therefore, by acquiring a drive signal for the galvanometer unit 144 from the laser control unit 148, which is the controller of the galvanometer unit 144, information related to the position of the molten pool P in the XY plane in the world coordinate system or the image plane coordinate system can be obtained. For example, the laser control unit 148 may acquire a drive signal related to the steering of the laser beam B in the XY plane. A drive signal for laser ON/OFF control is also acquired by the laser control unit 148. In such a case, an AD converter may be connected to the laser control unit 148 to acquire an analog output from the temperature sensor 112, in addition to the drive signal related to the steering of the laser beam B. By integrating these drive signals and a signal carrying information about the surface temperature of the material layer 10, XY coordinate values related to the position of the molten pool P can be calculated.

However, with such a method, since it is necessary to acquire signals from the laser control unit 148 and other components, the overall system configuration and processing tend to become complicated. In particular, if the supplier (manufacturer) of the laser control unit 148 and the components for estimating local parameters are different, it becomes necessary to provide a BUS or the like for signal extraction between the galvanometer unit 144 and the laser control unit 148, and the entire system tends to become expensive. In contrast, a method of numerically calculating coordinate values from an image of spatter S is simple and inexpensive.

In this embodiment, the analysis unit 210 calculates or acquires not only the XY coordinate values of the molten pool P but also the Z coordinate value. The method for determining the Z coordinate value is not particularly limited, and various methods may be used.

As is well known, in additive manufacturing, after forming a solidified layer by irradiating the material powder constituting a material layer with a laser, the build table is lowered by a predetermined step, the recoater head is moved, and a new material layer is formed on the solidified layer. Then, by irradiating the material layer on the solidified layer with a laser, a second solidified layer is formed on the solidified layer. That is, if the image acquisition unit 110 performs imaging, for example, at regular intervals, the recoater head 136 will appear in the image of spatter S every time a material layer 10 is formed. The analysis unit 210 can count the number of times the build table 5 has been lowered by detecting the recoater head 136 in the image by image analysis or the like. The number of times the build table 5 has been lowered is stored, for example, in the memory 14 and updated each time the lowering of the build table 5 is detected. In other words, this means that the analysis unit 210 can determine the cumulative number of solidified layers by detecting an image including the recoater head 136, and the analysis unit 210 can obtain the Z coordinate value of the molten pool P from the cumulative number of solidified layers through image analysis.

As another method for acquiring the Z coordinate value, a method of acquiring and analyzing a log of commands from the numerical control unit 50 can be exemplified. As shown in FIG. 8, herein, the control unit 150 of the additive manufacturing device 100 includes the table control unit 158 connected to the numerical control unit 50. The table control unit 158 controls the operation of the actuator 7 that moves the build table 5 up and down, based on commands from the numerical control unit 50. The analysis unit 210 can count the lowering of the build table 5, for example, by acquiring a log of commands from the numerical control unit 50 to the table control unit 158. Since the number of times the build table 5 has been lowered can be considered the same as the cumulative number of solidified layers, it is also possible to calculate the Z coordinate of the molten pool P by analyzing the log of commands from the numerical control unit 50 and determining the cumulative number of solidified layers. However, the method of calculating the Z coordinate by analyzing the image acquired by the image acquisition unit 110 is still advantageous in that the process of calculating the Z coordinate can be completed in a form independent of the format of the data output from the numerical control unit 50.

### (1.2.4 Visualizing Local Parameter in Association With Coordinates)

The analysis unit 210, having obtained the estimated value of the local parameter using the trained model LM and the coordinates of the molten pool P, visualizes them not individually but in a form linked to each other. As can be understood from the description so far, for example, the porosity as a local parameter and the three-dimensional coordinates indicating the position of the molten pool P are acquired for each image of spatter S. Hereinafter, an example of the representation of porosity when porosity is estimated as a local parameter will be described.

As described above, in the configuration illustrated in FIG. 8, the estimated value of porosity and the three-dimensional coordinates of the molten pool P, obtained for each image of spatter S, are held in the memory 14 in a mutually associated manner. The image generation unit 16 of the analysis unit 210 reads this associated data held in the memory 14 and generates a three-dimensional image based on the read data. The image generation unit 16 displays the three-dimensional image based on the data read from the memory 14 on the display unit 220, for example.

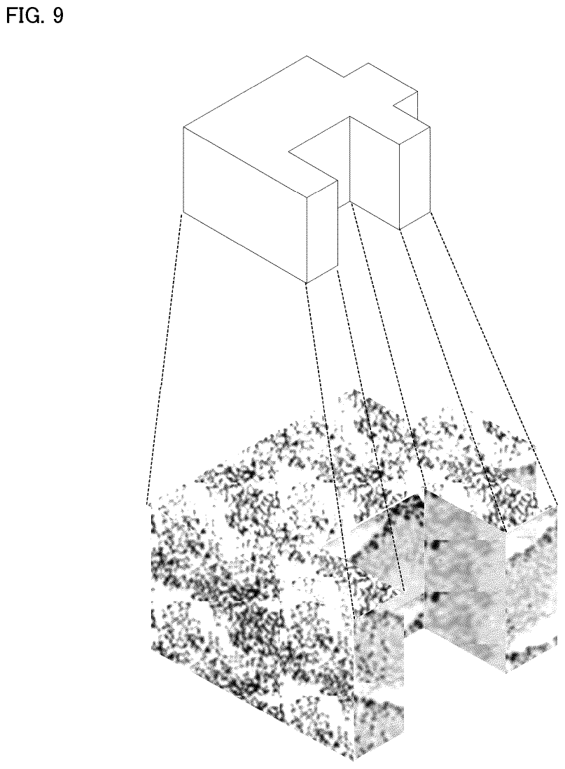

FIG. 9 shows an example of the representation of porosity by the build state estimation system 1000. Here, the local parameter is data representing the porosity of each part of the build object, obtained for each set of coordinates of the molten pool P. In other words, in a typical embodiment, the porosity as a local parameter is given as a set with the three-dimensional coordinate value of each part of the build object. Therefore, the image generation unit 16 can three-dimensionally visualize the porosity mapped onto the shape of the build object.

In the example shown in FIG. 9, the image generation unit 16 constructs a three-dimensional image as shown in the lower part, regarding a build object having the shape shown in the upper part, based on the set of porosity and three-dimensional coordinate values. In this example, the porosity of each part of the build object is represented using a grayscale. In the three-dimensional image shown in the lower part of FIG. 9, for example, portions rendered with a relatively low brightness have a small estimated value of porosity. In other words, regions of the build object with a relatively high material density are represented in a color close to black.

It goes without saying that the representation of porosity is not limited to the brightness of the pixels constituting the three-dimensional image. For example, a three-dimensional image may be drawn by a set of dots. By changing the gradation (brightness), size, or color of each dot according to the magnitude of the porosity, the porosity for each part of the build object can be visually represented. The image generation unit 16 may be configured to be able to switch between a plurality of representations and display them on the display unit 220.

As understood from the description so far, the build state of the completed build object can be given by point cloud data, wherein each point in the data cloud may comprise a set of three-dimensional coordinates from the molten pool P and a corresponding local parameter (e.g., porosity). In this embodiment, the analysis unit 210 generates a three-dimensional image regarding the build state of the build object based on this point cloud data and displays it on the display unit 220 of the external computing device 200 or the operation panel of the additive manufacturing device 100, or other suitable display devices. As a result, the designer of the build object can easily and visually assess the quality of the completed build object in a form associated with the shape of each part of the build object. According to this embodiment, for example, defects such as an unintentional increase in porosity or a low porosity in a portion that was intended to have a low density (for example, volume density) are visualized. In response to this, the operator of the build state estimation system 1000 can appropriately adjust the laser irradiation conditions during the build to the next build, and embodiments of the present invention contribute to a reduction in the defective product rate.

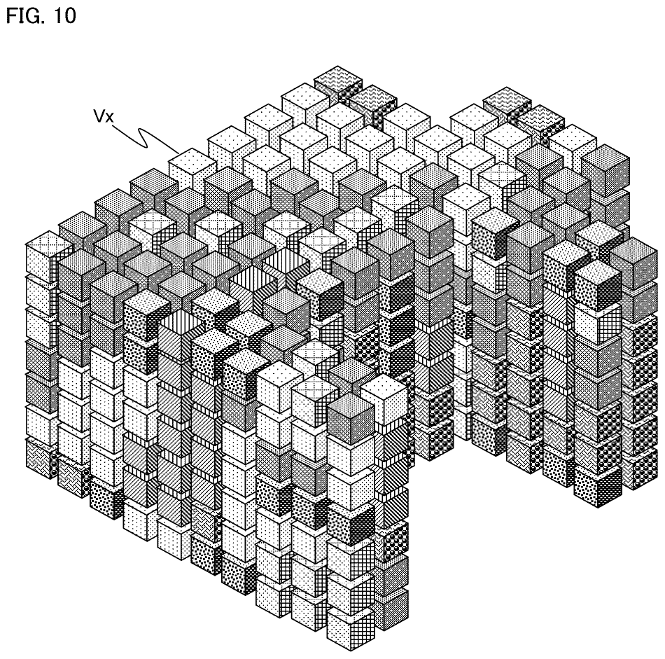

FIG. 10 shows another example in which porosity is three-dimensionally visualized in connection with the shape of a build object. In the example shown in FIG. 10, the three-dimensional shape of the build object is represented by a set of voxels Vx, and here, the porosity of each part of the build object is indicated by the brightness of the voxel Vx. Thus, the three-dimensional image generated based on point cloud data is not limited to the example shown in FIG. 9. By handling the data dealt with by the analysis unit 210 in the format of point cloud data, image generation with various representations becomes possible. It is even easy to visualize the distribution of porosity in any selected cross-section of the build object.

As described above, according to an embodiment of the present invention, a local parameter (e.g., porosity) can be presented to an operator of the build state estimation system 1000 or a designer of the build object in a form linked with three-dimensional coordinate values. By receiving, for example, a presentation in the form of a three-dimensional image regarding the distribution of porosity in a finished product, the designer of the build object can easily and visually assess whether the additive manufacturing was completed with the desired quality. Also, when an unintended value is included in the local parameter, the operator of the build state estimation system 1000 can appropriately change the laser irradiation conditions and other process parameters for subsequent manufacturing runs. That is, since feedback to the manufacturing conditions becomes easy, the defect rate of build objects can be reduced and efficient additive manufacturing can be realized.

### (1.2.5 Feedback to Manufacturing Conditions)

According to the studies of the present inventors, the greater the energy the laser imparts to the material layer, the more molten material powder is scattered farther outward from the irradiation spot. In contrast, if the energy the laser imparts to the material layer is insufficient, the molten pool formed at the irradiation spot is small, and sufficient melting and solidification do not occur deep into the material layer, making voids more likely to form in the solidified layer. Therefore, the distribution of porosity within a build object indirectly reflects the appropriateness of the laser irradiation conditions during additive manufacturing. Acquiring an estimated value of local porosity allows for the determination of whether manufacturing parameters, such as laser power and spot diameter, were within an appropriate range, without destroying the build object.

Alternatively, the analysis unit 210 may obtain, from the trained model LM, an estimated value for one or more of the laser power, spot diameter, and laser power density of the laser beam B as a local parameter, instead of or in addition to the estimated value of porosity. The state of laser irradiation on the surface of the material layer 10 can vary from moment to moment as the build progresses. For example, by presenting the estimated value of the laser power in the form of a three-dimensional image as shown in FIG. 9 or FIG. 10, it becomes possible to directly and visually assess the temporal change in the laser power during additive manufacturing.

The determination of whether the manufacturing parameters were within an appropriate range may be performed by the analysis unit 210 of the external computing device 200 or the control unit 150 of the additive manufacturing device 100. In the example shown in FIG. 8, the numerical control unit 50, which constitutes a part of the control unit 150, has a memory 52 and a determination unit 54. In the memory 52, a threshold related to the irradiation conditions of the laser beam B (e.g., laser power) may be stored in advance. The determination unit 54, for example, acquires data related to a local parameter (e.g., laser power) obtained by the analysis unit 210 of the external computing device 200 from the learning unit 12 and compares it with the threshold stored in the memory 52. The determination unit 54 can determine whether a parameter such as laser power related to the manufacturing of the build object was within a predetermined range by comparing the estimated value of the local parameter with the threshold read from the memory 52.

When a determination result is obtained that a parameter related to the manufacturing of the build object (e.g., laser power) is outside the predetermined range, the determination unit 54 may update the setpoint for that parameter to an appropriate value. Upon receiving the parameter update by the determination unit 54, the numerical control unit 50 sends a command based on the updated setpoint to the laser control unit 148 for a subsequent manufacturing run. That is, the control unit 150 of the additive manufacturing device 100 may be configured to change the irradiation conditions of the laser beam according to the estimated value of local parameters. According to this embodiment, even if the actual laser irradiation conditions (such as laser power, spot diameter, or laser power density) during additive manufacturing deviate from the appropriate range, the proper laser irradiation conditions can be immediately applied to the next manufacturing run, and the defect rate of build objects can be efficiently reduced.

The update of the parameter related to the manufacturing of the build object by the determination unit 54 is not limited to changing the laser irradiation conditions. For example, a decrease in the laser power on the surface of the material layer 10 may be due to an increase in the fume concentration in the chamber 120, causing the laser beam B to be partially shielded by fumes. In such a case, the numerical control unit 50 may send a command to the laser control unit 148 to compensate for the attenuation of the laser power due to fumes, or it may send a command to the inert gas system control unit 128 to correct the settings related to the operation of the fume collector (e.g., the fan speed of the fume collector).

The magnitude of the porosity in a build object depends not only on the actual laser irradiation conditions on the material layer 10, considering the influence of fumes, but also on the shape of the build object. That is, even if the influence of laser attenuation due to fumes could be removed, the heat that the material powder receives from the laser can differ depending on the shape to be obtained after the melting and solidification of the material powder. For example, even within the same build object, there can be a difference in the quality of the solidified layer between a portion with sharp features and a more massive, bulk portion. In other words, there are at least two factors for the increase in porosity in a build object: a temporal factor and a shape-related factor. It is generally difficult to determine from only numerical monitoring of virtual porosity which of the temporal factor and the shape-related factor contributes more to the increase in (local) porosity.

In contrast, according to a typical embodiment of the present invention, a local parameter, such as porosity, can be presented to an operator and a designer in a form linked to the shape of the build object. Since more detailed information regarding the quality of the build object is presented, for example, in the form of a three-dimensional image, a typical embodiment of the present invention enables more appropriate setting of manufacturing conditions, taking into account both temporal and shape factors. Furthermore, by storing the local parameter (e.g., porosity) in a form linked to the shape of the build object, for example, as three-dimensional point cloud data, an effect of improving the traceability of the quality of the build object can also be expected.

### 2. Exemplary Operation Flow of Build State Estimation System 1000

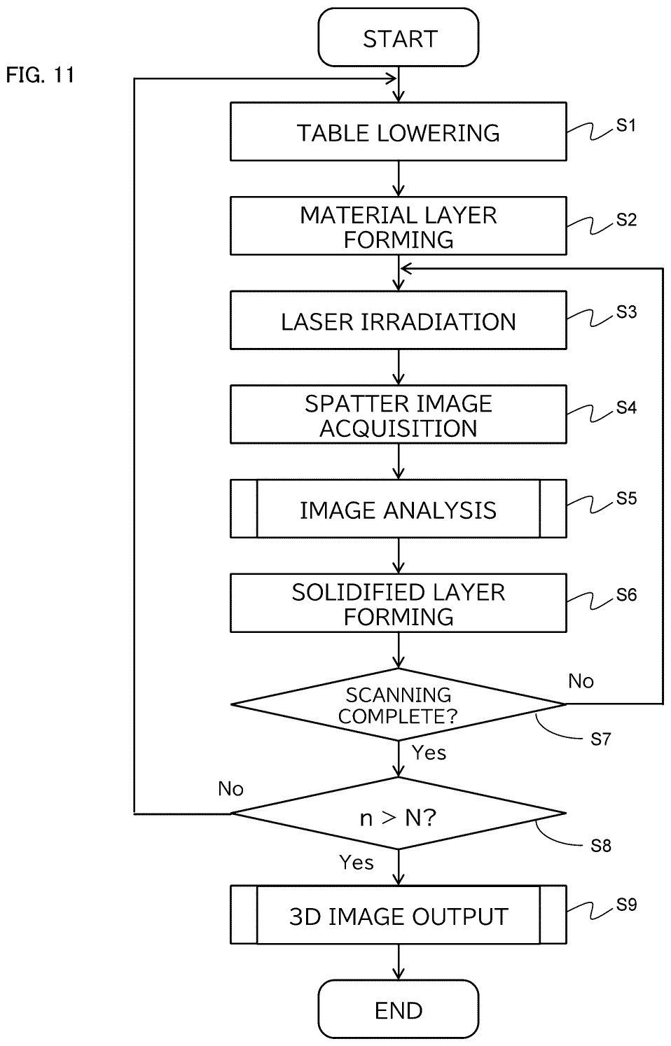

FIG. 11 is a flowchart illustrating an exemplary build state estimation method according to another embodiment of the present invention. In a typical embodiment of the present invention, the build state estimation method by the build state estimation system 1000 includes an image acquisition step and an analysis step. In general terms, the image acquisition step involves acquiring an image of spatter S generated around the molten pool P. The analysis step involves estimating a local parameter using machine learning. More specifically, the analysis step involves estimating a local parameter (e.g., porosity) by inputting one or more features related to the spatter S into a trained model LM and outputting the local parameter in a form associated with the coordinate values indicating the position of the molten pool P.

### (2.1 Table Lowering Step S1)

Prior to the start of additive manufacturing, the build space 120v is filled with an inert gas by introducing the inert gas into the chamber 120. Thereafter, the build table 5 is lowered by a predetermined amount along the Z-axis by driving the actuator 7 (see FIG. 1).

### (2.2 Material Layer Forming Step S2)

Next, by driving the actuator 32A, the recoater head 136 is moved along the X-axis from one end of the build area R to the other end. At this time, material powder is supplied from the reservoir 36R of the recoater head 136 to the build area R through the slit 36S (see FIG. 4) of the recoater head 136. By the movement of the recoater head 136, the material powder discharged from the recoater head 136 is leveled by the blade 35 and blade 37 of the recoater head 136, and a material layer 10 of a predetermined thickness is formed in the build area R (see FIG. 5). Optionally, the recoater head 136 may be reciprocated along the X-axis.

### (2.3 Laser Irradiation Step S3)

After the formation of the material layer 10, a selected location of the material layer 10 is irradiated with the laser beam B emitted from the laser irradiation device 140 (see FIG. 5). By scanning with the laser beam B, the material powder at the selected location in the material layer 10 can be selectively sintered or melted.

### (2.4 Spatter Image Acquisition Step S4)

In embodiments of the present invention, in parallel with the irradiation of the laser beam B, an image of spatter S (see FIGS. 6 and 7) generated around the molten pool P formed by the irradiation of the laser beam B is acquired by the image acquisition unit 110. The acquisition of the image of spatter S is performed in real time during the additive manufacturing process. The image data acquired by the image acquisition unit 110 is sent to the analysis unit 210 of the external computing device 200.

### (2.5 Image Analysis Step S5)

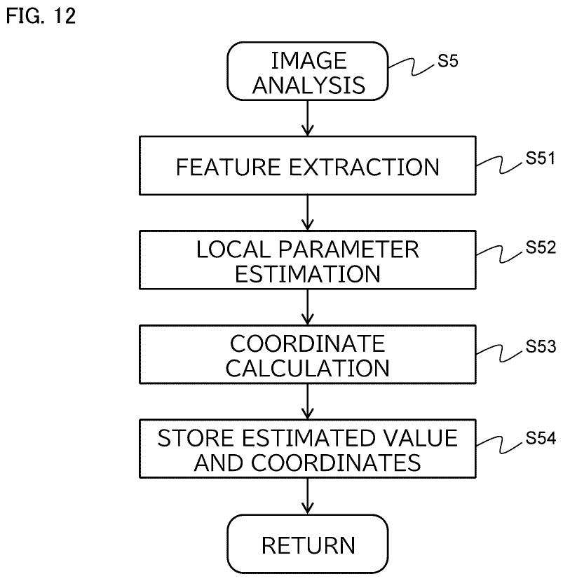

The analysis unit 210, upon receiving the image data of spatter S, performs the extraction of one or more features related to the spatter S from the image of spatter S and the estimation of a local parameter by inputting the features to the trained model LM, as described above. In addition, the analysis unit 210 also performs the calculation of coordinates indicating the position of the molten pool P from the image of spatter S. That is, the image analysis step S5 shown in FIG. 11 may include a feature extraction step S51, a local parameter estimation step S52, and a coordinate calculation step S53, as illustrated in FIG. 12. Regardless of the order illustrated in FIG. 12, the coordinate calculation step S53 may be performed before steps S51 and S52, or may be performed in parallel with the set of steps S51 and S52. Data related to the estimated value obtained as output from the trained model LM and data related to the coordinate values obtained using image analysis or the like are stored in the memory 14 (see FIG. 8) of the analysis unit 210, for example, in a mutually associated list form (step S54 shown in FIG. 12).

### (2.6 Solidified Layer Forming Step S6)

The material that has been sintered or melted by laser irradiation forms a solidified layer upon subsequent cooling. By scanning with the laser beam B and selectively sintering or melting portions of the material layer 10, a solidified layer having a desired shape can be obtained in the same manner as line drawing with a laser.

### (2.7 Scanning Completion Determination Step S7)

The scanning of the laser beam B is performed based on commands from the numerical control unit 50 of the additive manufacturing device 100. In step S7, a determination is made as to whether scanning for a given layer is complete. When the scanning for one layer is completed, the lowering of the build table 5, the formation of the material layer 10, and the scanning of the laser beam B on the material layer 10 are performed again (steps S1 to S3 in FIG. 11). Between the formation of a new material layer 10 on the solidified layer and the formation of a second solidified layer by laser irradiation on that new material layer 10, the acquisition of the image of spatter S by the image acquisition unit 110 (step S4 in FIG. 11) is performed again. This image acquisition may be performed at any timing between the formation of the new material layer 10 and the completion of the next solidified layer.

There is no particular limitation on the number of times the image of spatter S is acquired during the period from the formation of one material layer 10 to the formation of a solidified layer. The number of times the image of spatter S is acquired may be appropriately determined in consideration of the resolution of the three-dimensional image to be finally obtained, the amount of computational resources available for image analysis, and the like. In addition, it is not essential to complete the analysis of the image of spatter S related to a certain material layer 10 (or a certain solidified layer) in the period from the formation of that material layer 10 to the next lowering of the build table 5. It is also possible to have an operation in which the images of the spatter S acquired by the image acquisition unit 110 are accumulated in the memory 14 (see FIG. 8) or the like, and the image analysis step S5 of the image of spatter S is performed after the completion of additive manufacturing.

### (2.8 Build Completion Determination Step S8)

The build object is manufactured by repeating the material layer forming step by supplying material powder onto the build area R and the solidified layer forming step by scanning with the laser beam B. When the number of times these steps are executed (n times) exceeds a predetermined number of times (for example, N times), the additive manufacturing device 100 terminates the additive manufacturing. The completion of additive manufacturing can be determined, for example, by counting the number of times the build table 5 has been lowered and holding it in the memory 52 of the numerical control unit 50 or the like, and comparing it with a predetermined threshold N.

### (2.9 Three-dimensional Image Output Step S9)

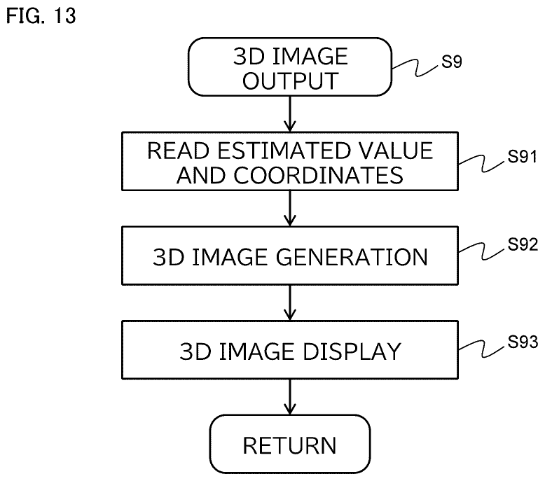

As illustrated in FIG. 11, the build state estimation method may additionally include a three-dimensional image output step S9. As illustrated in FIG. 13, the three-dimensional image output step S9 may include an estimated value and coordinate value reading step S91, a three-dimensional image generation step S92, and a three-dimensional image display step S93.

In the output of the three-dimensional image, the image generation unit 16 (see FIG. 8) of the analysis unit 210 reads a plurality of sets, each including an estimated value and coordinate values, held in the memory 14 (step S91 in FIG. 13). All the sets of data, each set including data related to the estimated value of the local parameter and data related to the coordinate values of the molten pool P constitute so-called point cloud data. The image generation unit 16 generates a three-dimensional image as shown in, for example, FIG. 9 or FIG. 10 based on the read data (step S92 in FIG. 13). Since the set of data includes information on the coordinate values of the molten pool P, the generated three-dimensional image reflects the shape of the completed build object. The three-dimensional image generated by the image generation unit 16 is displayed, for example, on the screen of the display unit 220 of the external computing device 200 (step S93 in FIG. 13).

Optionally, the determination unit 54 may determine whether the local parameter is within a predetermined range. Based on the determination result, the laser irradiation conditions may then be updated or corrected. Accordingly, the build state estimation method may additionally include a laser irradiation condition changing step.

### 3. Other Embodiments of Build State Estimation System

### (3.1 Additive Manufacturing Using Multiple Laser Beams)

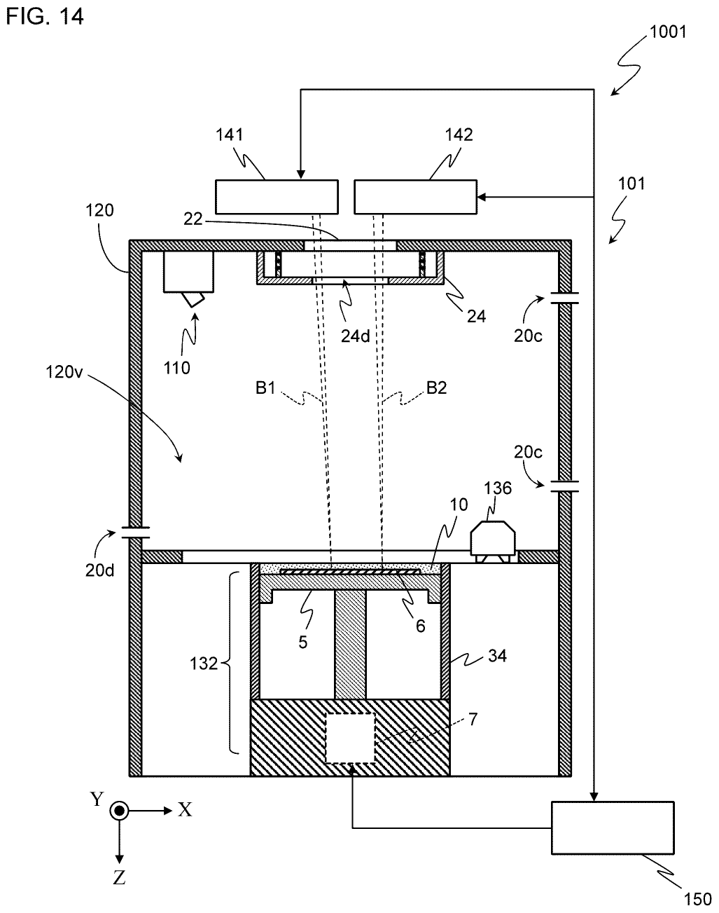

FIG. 14 schematically illustrates an exemplary build state estimation system according to still another embodiment of the present invention. A build state estimation system 1001 shown in FIG. 14 differs from the build state estimation system 1000 explained with reference to FIGS. 1 to 6 in that it has an additive manufacturing device 101 instead of the additive manufacturing device 100. In FIG. 14, the illustration of the external computing device 200 is omitted to avoid overcomplicating the drawing.

As schematically shown in FIG. 14, the additive manufacturing device 101 includes a laser irradiation device 141 and a laser irradiation device 142, both arranged above the chamber 120. That is, in the embodiment described here, the additive manufacturing device 101 includes two or more laser irradiation heads.

As schematically shown in FIG. 14, in additive manufacturing using the additive manufacturing device 101, each of the two laser irradiation heads independently irradiates the material layer 10 with a laser beam. In the example shown in FIG. 14, the laser irradiation device 141 scans the material layer 10 with a laser beam B1, and the laser irradiation device 142 scans the material layer 10 with a laser beam B2. That is, in this example, two molten pools can be formed simultaneously at separate locations on the material layer 10. In this example, the material layer 10 is irradiated with the laser beam B1 from the laser irradiation device 141 and the laser beam B2 from the laser irradiation device 142 through a common window 22 and a common fume diffusion unit 24. This configuration is not limiting; a window for passing the laser beam and a fume diffusion unit may be provided for each laser irradiation device.

Similar to the above-described embodiment, the image acquisition unit 110 captures an image of the build area R and acquires an image of the spatter generated around the molten pool formed by the irradiation of the laser beam. However, here, corresponding to the fact that the material layer 10 is irradiated with two beams, the laser beam B1 and the laser beam B2, the image acquired by the image acquisition unit 110 includes two images of molten pools. In other words, the image acquisition unit 110 acquires an image of spatter generated around each of the molten pools formed by the irradiation of the two laser beams.

The analysis unit 210 of the external computing device 200 performs the extraction of features and the calculation of coordinates from the spatter image, similarly to the above-described embodiment. However, here, the analysis unit 210 performs the extraction of features and the calculation of coordinates for each of the multiple molten pools formed on the material layer 10, from the image acquired by the image acquisition unit 110.

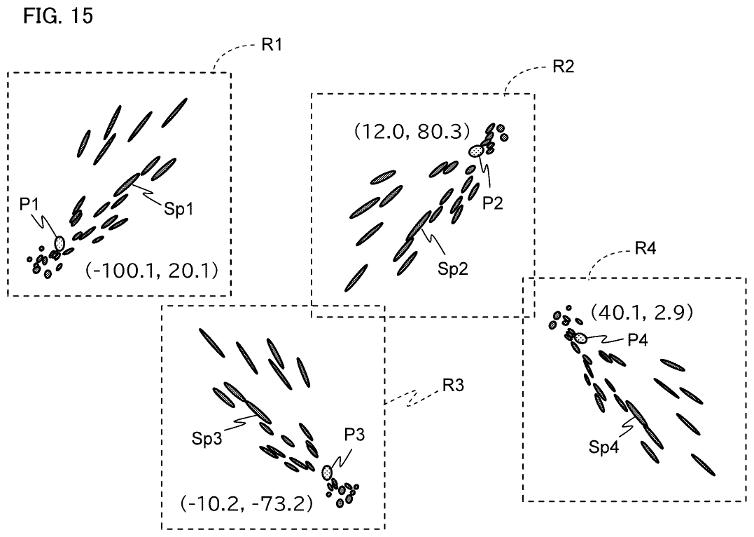

FIG. 15 is an example of an image of spatter S obtained when the material layer 10 is simultaneously irradiated with four laser beams. In the example shown in FIG. 15, four molten pools, namely, molten pool P1, molten pool P2, molten pool P3, and molten pool P4, are formed at different locations on the material layer 10, and spatter occurs at each of these molten pools.

As in this example, when the image acquired by the image acquisition unit 110 includes images of multiple molten pools, the analysis unit 210, upon receiving the image data sent from the image acquisition unit 110, first executes clipping into four regions that respectively include molten pool P1, molten pool P2, molten pool P3, and molten pool P4, in the image analysis step S5 described above (see FIG. 11). For example, the analysis unit 210 clips four regions, region R1, region R2, region R3, and region R4, from the image acquired by the image acquisition unit 110, as indicated by the dashed rectangles in FIG. 15. Region R1 includes an image of molten pool P1 and an image of the surrounding spatter Sp1. Similarly, region R2 includes an image of molten pool P2 and an image of the surrounding spatter Sp2, and region R3 includes an image of molten pool P3 and an image of the surrounding spatter Sp3. Region R4 includes an image of molten pool P4 and an image of the surrounding spatter Sp4.

The method of clipping multiple regions, each including an image of a molten pool, from the image acquired by the image acquisition unit 110 is not limited to a specific method and may be executed by any appropriate method that can achieve the objective. For example, a region encompassing images of multiple particles constituting the spatter may be detected, and a high-luminance and roughly circular portion located near the geometric center of the figure defining the shape of that region may be identified as a molten pool. Alternatively, the clipping of multiple regions, each including an image of a molten pool, may be executed by machine learning.

In the feature extraction step S51 (see FIG. 12), the analysis unit 210 treats each of the clipped regions as an image of spatter generated around a molten pool and extracts features from each of regions R1 to R4. In the subsequent local parameter estimation step S52, the analysis unit 210 inputs the features for each image corresponding to the clipped regions into the trained model LM and obtains estimated values of the local parameter for each of these images. In the coordinates calculation step S53, the analysis unit 210 executes the calculation of coordinates indicating the position of the molten pool for each image corresponding to the clipped regions. In FIG. 15, planar coordinates of respective molten pools (e.g., (−100.1, 20.1) for the molten pool P1, and so forth) are also shown. In the subsequent storage step S54, four sets of estimated values and coordinates, one for each clipped region, are stored in the memory 14.

As shown in FIG. 15, when irradiating the material layer 10 with, for example, four laser beams, four independent build objects can be manufactured in parallel. By extracting features from the images of the respective spatters, Sp1 through Sp4, and estimating the local parameters, a three-dimensional image as exemplified in FIG. 9 and FIG. 10 can be obtained for each build object. That is, according to this embodiment, it is possible to easily assess the quality of each build object. Of course, a single build object may be manufactured with multiple laser beams. In that case, the lead time required for manufacturing the build object can be shortened, and the collection of local parameters for generating a three-dimensional image as exemplified in FIG. 9 and FIG. 10 can be accelerated.

As described above, in the method of acquiring drive signals related to the steering of the laser beam from the laser control unit and calculating the coordinates related to the position of the molten pool, the entire system tends to become complex and expensive. If the number of laser irradiation devices increases, the entire system becomes even more complex, and it is also necessary to know in advance the number of laser irradiation devices that are emitting laser beams at the time of image acquisition. In contrast, according to the method using image analysis as in this embodiment, the coordinate values can be numerically calculated simply and inexpensively.

### (3.2 Use of a Trained Model Via Network)

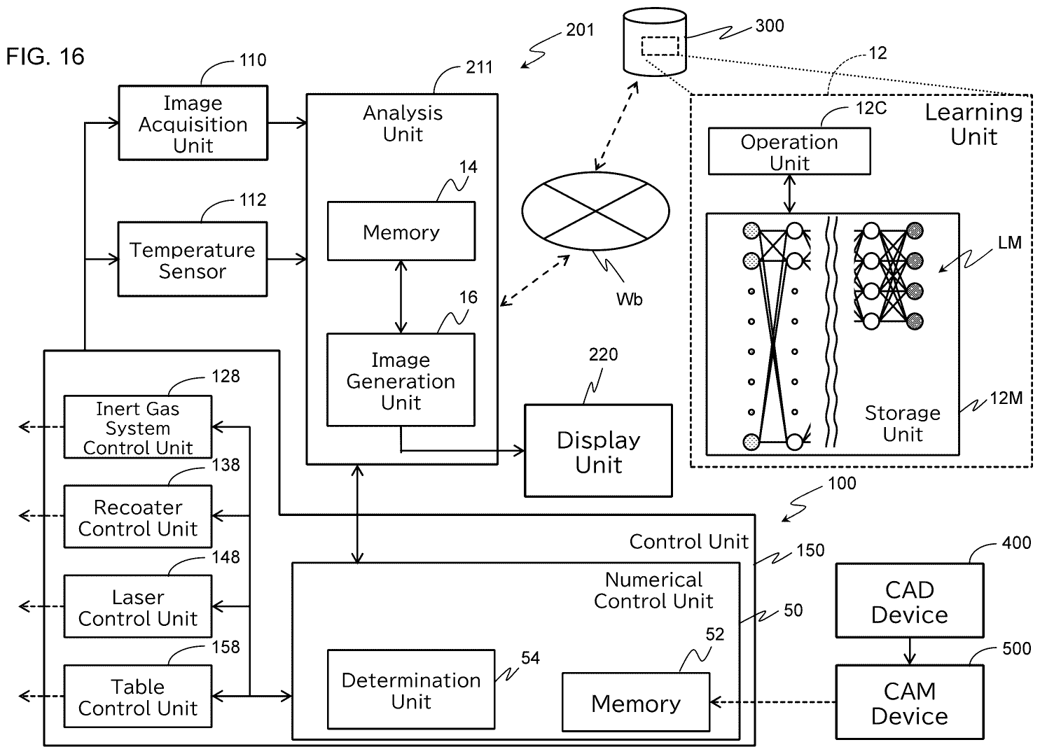

FIG. 16 is a functional block diagram of a build state estimation system according to still another embodiment of the present invention. Compared to the example explained with reference to FIG. 8, in the example shown in FIG. 16, a build state estimation system is constructed by combining an external computing device 201 with the additive manufacturing device 100 instead of the external computing device 200. In the configuration illustrated in FIG. 16, the external computing device 201 includes an analysis unit 211 instead of the analysis unit 210. As schematically shown in FIG. 16, the analysis unit 211 of the external computing device 201 does not include the above-mentioned learning unit 12.

Here, the learning unit 12 including the storage unit 12M in which the trained model LM is stored is housed in a server 300 separate from the external computing device 201. The server 300 is configured to be able to communicate with the external computing device 201 via a network Wb such as the Internet.

The analysis unit 211 of the external computing device 201, after extracting one or more features related to the spatter S, sends data related to the features to the server 300 via the network Wb. The server 300, based on an instruction from, for example, the analysis unit 211, inputs the data related to the features to the trained model LM and returns the estimated value output from the trained model LM to the analysis unit 211 via the network Wb. The analysis unit 211 also executes the calculation of coordinates indicating the position of the molten pool P. The analysis unit 211 stores the estimated value obtained from the trained model LM in, for example, the memory 14 in a form associated with the coordinates of the molten pool P.

Thus, it is not essential that the external computing device of the build state estimation system includes the trained model LM that returns an estimated value of a local parameter as an output. The deployment of the trained model LM may be either server-side model deployment as shown in FIG. 16, or client-side model deployment as shown in FIG. 8. Alternatively, a hybrid model deployment, in which the trained model LM is deployed to both the external computing device of the additive manufacturing system and an external server, may also be adopted.

### 4. Other Configurations of Build State Estimation System

Next, other configuration details of the build state estimation system 1000 will be described again with reference to FIG. 8.

### (4.1 Cam Device and Cad Device)

As described above, in the configuration illustrated in FIG. 8, the control unit 150 of the additive manufacturing device 100 includes the numerical control unit 50. The numerical control unit 50 sends commands to controllers for operating each part of the additive manufacturing device 100, such as the inert gas system control unit 128, the recoater control unit 138, the laser control unit 148, and the table control unit 158, based on a machine-readable machining program in which instructions for obtaining the shape of the build object are described. The machining program is prepared by a device separate from the additive manufacturing device 100 and is stored in advance in the memory 52 of the numerical control unit 50 before the start of additive manufacturing.

Here, the above-mentioned machining program is prepared prior to additive manufacturing by a CAM device 500 installed outside the additive manufacturing device 100, and is sent from the CAM device 500 to the control unit 150 of the additive manufacturing device 100 by wired or wireless communication. The CAM device 500, upon importing a file describing data representing a three-dimensional model related to the build object (hereinafter referred to as a “CAD model” for convenience) prepared by a CAD device 400, generates a machining program based on the CAD data.

The CAD device 400 and the CAM device 500 may each be independent devices, or the CAD device 400 and the CAM device 500 may be implemented on a single computing device. For example, a machining program may be generated using a personal computer on which a CAD tool is installed in addition to CAM software. In such a configuration, the transfer of the CAD model from the CAD tool to the CAM software is completed within that computer.

The CAD model may be used in generating the three-dimensional images as shown in FIG. 9 and FIG. 10. For example, by appropriately mesh-dividing the CAD model and assigning an estimated value of porosity to each divided region, the estimated value of the local parameter can also be expressed in a form associated with the geometric shape of the build object.

### (4.2 Trained Model LM)

In embodiments of the present invention, model inference is performed using a machine-learning-based trained model LM that outputs a local parameter such as porosity, with one or more features of a spatter particle as input. There is no particular limitation on the architecture of the trained model LM, and here, a neural network model including an input layer to which the features of a spatter particle are given, an output layer that outputs a local parameter, and one or more hidden layers (for example, seven hidden layers) is applied to the trained model LM. The machine learning in embodiments of the present invention is not limited to a neural network-type method, and may be executed based on various methods that can be learned using, for example, a large amount of training data (a set of known input data and correct answer data). The edges and nodes shown in FIG. 8 are merely examples for convenience of explanation and do not limit the actual architecture of the trained model LM.

For learning of the neural network model, for example, supervised learning can be applied. The training data can be prepared by performing preliminary test builds, as described in Japanese Patent Publication No. 2022-121427. More specifically, additive manufacturing is performed while acquiring images of spatter by changing the irradiation conditions of the laser beam and other process parameters. From the cross-sectional observation and other analyses of the build object obtained at this time, a dataset consisting of the features of the spatter particles extracted from the spatter image and the irradiation conditions of the laser beam, and the corresponding measured value of porosity, can be obtained. The learning of the neural network model can be performed using the dataset thus obtained as training data.

As described above, the heat that the material powder receives from the laser depends on the shape of the build object to be obtained. That is, even if the laser irradiation conditions are the same, the manner of spatter scattering differs, for example, between a central portion and an end portion of the three-dimensional shape of the build object. Taking this into account, the training data may be prepared in a way that accounts for the three-dimensional shape of the build object, thereby enabling more accurate estimations.

For the storage unit 12M that holds the trained model LM, the memory 14 of the analysis unit 210, and the memory 52 of the above-mentioned numerical control unit 50, volatile memory such as RAM, and non-volatile memory such as a magnetic disk drive or a solid-state drive (SSD) can be used according to the purpose. For the image generation unit 16, the operation unit 12C of the learning unit 12, and the numerical control unit 50 that the additive manufacturing device 100 has, one or more processors such as a CPU or a GPU can be used according to the purpose.

### (4.3 Other Configurations)

The configuration of the build state estimation system is not limited to the examples shown in FIGS. 8 and 16. A build state estimation system may be constructed from a combination of either the additive manufacturing device 100 or the additive manufacturing device 101, and either the external computing device 200 or the external computing device 201.

It is not essential for embodiments of the present invention that the additive manufacturing device 100 and the additive manufacturing device 101 have the image acquisition unit 110. The image acquisition unit 110 may be a part of the external computing device 200 or the external computing device 201. For example, according to the method of calculating the coordinates of the molten pool from the spatter image, it is possible to complete the image analysis step S5 and the three-dimensional image output step S9 shown in FIG. 11 within the external computing device. This means that the build state estimation method according to the present invention can be applied by retrofitting the image acquisition unit 110 and the external computing device 200 or the external computing device 201 to an existing additive manufacturing device. For this reason as well, the present invention is useful.

The foregoing description of the embodiments has been provided for purposes of illustration and description. It is not intended to be exhaustive or to limit the disclosure to the precise forms disclosed. Numerous modifications and variations are possible in light of the above teachings. Various omissions, substitutions, and changes in the form of the methods and systems described herein may be made by those skilled in the art without departing from the spirit and scope of the invention. The embodiments and their modifications are included within the spirit and scope of the invention, and are also encompassed by the appended claims and their equivalents.

What is claimed is:

1. A system for estimating a build state of a build object, comprising:
an image acquisition unit; and
an analysis unit, wherein
the build object is manufactured by repeating
(a) forming a material layer by supplying material powder onto a build area, and
(b) forming a solidified layer via irradiation of the material layer with one or more laser beams,
the image acquisition unit acquires, in real time, an image of spatter generated around each molten pool formed by the irradiation of the one or more laser beams, and
the analysis unit extracts at least one feature related to the spatter from the image and calculates coordinates indicating a position of the molten pool, estimates a local parameter representing the build state of the solidified layer by inputting the at least one feature to a trained model, and outputs the local parameter in a form associated with the coordinates.

2. The system of claim 1, wherein the local parameter is data representing a porosity of each part of the build object, associated with respective coordinates.

3. The system of claim 1, wherein the analysis unit generates a three-dimensional image related to the build state of the build object, represented by point cloud data which is a collection of individual data sets, where each data set consists of the coordinates and the associated local parameter.

4. The system of claim 1, further comprising a control unit, wherein
the control unit controls an operation of a recoater head that supplies the material powder onto the build area,
the coordinates include a Z coordinate value related to a height direction of the build object in addition to planar coordinates within the build area, and
the analysis unit calculates the Z coordinate value by determining a cumulative number of the solidified layers by detecting an image including the recoater head among a series of images acquired by the image acquisition unit.

5. The system of claim 1, further comprising a control unit, wherein
the coordinates include a Z coordinate value related to a height direction of the build object in addition to planar coordinates within the build area, and
the analysis unit calculates the Z coordinate value by determining a cumulative number of the solidified layers by analyzing a log of commands from the control unit.

6. The system of claim 4, wherein the control unit changes an irradiation condition of at least one of the laser beams according to an estimated value of the local parameter.

7. The system of claim 5, wherein the control unit changes an irradiation condition of at least one of the laser beams according to an estimated value of the local parameter.

8. The system of claim 1, wherein the one or more laser beams include a plurality of laser beams, and the analysis unit extracts the at least one feature for each molten pool and calculates the coordinates indicating a position of a respective molten pool from the image.

9. A method of estimating a build state of a build object, comprising:
an image acquisition step; and
an analysis step,
wherein the build object is manufactured by repeating:
(a) forming a material layer by supplying material powder onto a build area, and
(b) forming a solidified layer via irradiation of the material layer with one or more laser beams, wherein the irradiation forms one or more molten pools within the material layer,
wherein the image acquisition step comprises acquiring, in real time, an image of spatter generated around each of the molten pools, and
wherein the analysis step comprises:
estimating a local parameter representing the build state of the solidified layer by inputting at least one feature related to the spatter to a trained model, and
outputting the local parameter in a form associated with coordinates indicating a position of a respective one of the molten pools.

10. The method of claim 9, wherein the analysis step further comprises:
a step of extracting the at least one feature from the image; and
a step of calculating the coordinates from the image.
